(19) United States
(12) Patent Application Publication
(10) Pub. No.: US 2026/0161207 A1
(43) Pub. Date: Jun. 11, 2026

(54) STORAGE DEVICE AND OPERATING METHOD OF CONTROLLER

(71) Applicant: SK hynix Inc., Icheon-si (KR)

(72) Inventors: Hyo Byung Han, Icheon-si (KR); Young Wu Choi, Icheon-si (KR)

(21) Appl. No.: 19/195,158

(22) Filed: Apr. 30, 2025

(30) Foreign Application Priority Data
Dec. 9, 2024 (KR) 10-2024-0181692

(51) Int. Cl. G06F 1/20

(52) U.S. Cl. CPC G06F 1/206

(57) ABSTRACT

A storage device includes a memory device and a controller. The controller is configured to, when a temperature zone is changed between a first temperature update time point and a second temperature update time point, determine a temperature zone change time point based on temperature information, wherein the temperature information includes a first temperature at the first temperature update time point and a second temperature at the second temperature update time point, check whether a temperature at a read time point for the memory device is within an abnormal temperature zone based on the temperature information and the temperature zone change time point, wherein the read time point occurs between the first temperature update time point and the second temperature update time point, and increase a read count by an increment determined based on a result of the checking.

### CROSS-REFERENCES TO RELATED APPLICATION

The present application claims priority under 35 U.S.C. § 119(a) to Korean Patent Application Number 10-2024-0181692, filed on Dec. 9, 2024, in the Korean Intellectual Property Office, which is incorporated herein by reference in its entirety.

### BACKGROUND

### 1. Technical Field

Various embodiments may generally relate to a storage device including a memory device.

### 2. Related Art

A storage device is configured to store data provided from an external device in response to a write request from the external device. The storage device is configured to provide data stored therein to the external device in response to a read request from the external device. The external device is an electronic device configured to process data and include a computer, a digital camera, a mobile phone, or the like. The storage device may be built in the external device to operate or may be manufactured to be separated from the external device and coupled to the external device to operate. The storage device may include a memory device configured to store data.

Temperature in the storage device may significantly impact operational performance and reliability. A high temperature environment may accelerate charge leakage within memory cells, deteriorating data retention characteristics. Conversely, a low temperature environment may reduce current flow, degrading the program and read performance of the memory device. Accordingly, to ensure stable performance, the storage device may use various compensation methods to adapt to temperature changes. Furthermore, the storage device may use various defense algorithms to mitigate errors and prevent damage when exposed to abnormal environmental conditions.

### SUMMARY

In an embodiment of the present disclosure, a storage device may include a memory device; and a controller. The controller may be configured to, when a temperature zone is changed between a first temperature update time point and a second temperature update time point, determine a temperature zone change time point based on temperature information, wherein the temperature information includes a first temperature at the first temperature update time point and a second temperature at the second temperature update time point. The controller may be further configured to check whether a temperature at a read time point for the memory device is within an abnormal temperature zone based on the temperature information and the temperature zone change time point, wherein the read time point occurs between the first temperature update time point and the second temperature update time point. The controller may be further configured to increase a read count by an increment determined based on a result of the checking.

In an embodiment of the present disclosure, an operating method of a controller of a storage device may include, when a temperature zone is changed between a first temperature update time point and a second temperature update time point, determining a temperature zone change time point based on temperature information, wherein the temperature information includes a first temperature at the first temperature update time point and a second temperature at the second temperature update time point. The method may further include checking whether a temperature at a read time point for a memory device is within an abnormal temperature zone based on the temperature information and the temperature zone change time point, wherein the read time point occurs between the first temperature update time point and the second temperature update time point. The method may further include increasing a read count by an increment, which is determined based on a result of the checking.

In an embodiment of the present disclosure, an operating method of a controller of a storage device may include determining a preliminary increment based on a first temperature at a first temperature update time point preceding a read time point and increasing a read count by the preliminary increment. The method may further include determining whether a temperature zone is changed based on the first temperature and a second temperature at a second temperature update time point following the read time point, and determining a temperature zone change time point when the temperature zone is changed. The method may further include determining whether compensation for the read count increased by the preliminary increment is necessary based on the temperature zone change time point, and compensating the read count when the compensation is necessary.

In an embodiment of the present disclosure, a storage device may include a memory device; and a controller. The controller may be configured to calculate a temperature zone change time point between a first temperature update time point and a second temperature update time point based on a first temperature at the first temperature update time point and a second temperature at the second temperature update time point, wherein the temperature zone change time point corresponds to a boundary temperature distinguishing an abnormal temperature zone from a normal temperature zone; and identify an internal operation of the memory device performed in the abnormal temperature zone based on the temperature zone change time point.

### BRIEF DESCRIPTION OF THE DRAWINGS

The above and other aspects, features and advantages of the subject matter of the present disclosure will be more clearly understood from the following detailed description taken in conjunction with the accompanying drawings, in which:

FIG. 1 is a block diagram illustrating a storage device according to an embodiment of the present disclosure;

FIG. 2 is a diagram illustrating temperature zone change time points according to an embodiment of the present disclosure;

FIGS. 3 and 4 are diagrams illustrating a method for determining the increment of a read count without considering temperature zone change time points according to an embodiment of the present disclosure;

FIGS. 5 and 6 are diagrams illustrating a method for determining the increment of a read count by determining a temperature zone change time point according to an embodiment of the present disclosure;

FIG. 7 is a flowchart illustrating an operating method of a controller according to an embodiment of the present disclosure;

FIG. 8 is a flowchart illustrating an operating method of a controller according to an embodiment of the present disclosure; and

FIG. 9 is a flowchart illustrating an operating method of a controller according to an embodiment of the present disclosure.

### DETAILED DESCRIPTION

Various embodiments of the present teachings are described in detail with reference to the accompanying drawings. The drawings are schematic illustrations of various embodiments (and intermediate structures). As such, variations from the configurations and shapes of the illustrations as a result, for example, of manufacturing techniques and/or tolerances, are to be expected. Thus, the described embodiments should not be construed as being limited to the particular configurations and shapes illustrated herein but may include deviations in configurations and shapes which do not depart from the spirit and scope of the present teachings as defined in the appended claims.

The present teachings are described herein with reference to cross-section and/or plan illustrations of idealized embodiments of the present teachings. However, embodiments of the present teachings should not be construed as limiting the present teachings. Although a few embodiments of the present teachings are shown and described, it will be appreciated by those of ordinary skill in the art that changes may be made in these embodiments without departing from the principles and spirit of the present teachings.

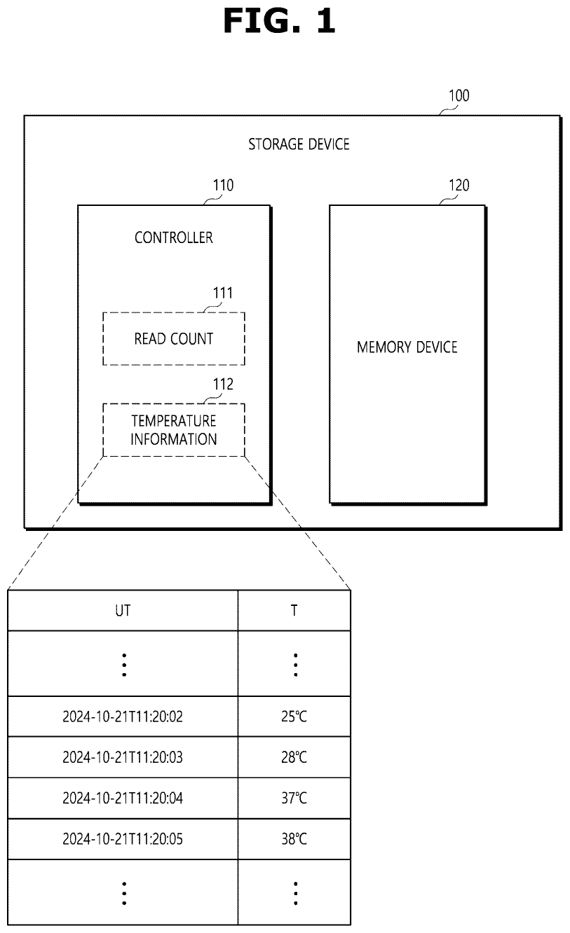

FIG. 1 is a block diagram illustrating a storage device 100 according to an embodiment.

Referring to FIG. 1, the storage device 100 includes a controller 110 and a memory device 120.

The controller 110 may control the memory device 120 in response to a request from a host device (not shown). For example, the controller 110 may store data received from the host device in the memory device 120 in response to a write request from the host device. Further, the controller 110 may read data from the memory device 120 and transmit the read data to the host device in response to a read request from the host device.

The controller 110 may independently perform a management operation to maintain the operational performance of the storage device 100 and extend the lifespan of the memory device 120, even in the absence of a request from the host device. The controller 110 may perform the management operation in a background or a foreground. The management operation may include a wear leveling operation, a duplicate removal operation, a garbage collection operation, or the like. According to an embodiment, the controller 110 may also perform the management operation in response to a request from the host device.

The controller 110 may manage a read count 111 to track the number of read operations performed on the memory device 120. The read count 111 may be maintained separately for specific memory units, such as a page, word line, memory block, plane, memory die, memory chip, and the like. The controller 110 may increase the read count 111 each time a read operation is executed in response to a read command transmitted to the memory device 120. Additionally, the controller 110 may increase the read count 111 based on a predefined data size unit for each read operation.

The time point of increasing the read count 111 for a read operation may vary according to embodiments. For an embodiment, the controller 110 may increase the read count 111 after transmitting a read command to the memory device 120. In another embodiment, the controller 110 may increase the read count 111 while simultaneously controlling the read operation. In further another embodiment, the controller 110 may increase the read count 111 upon completion of the read operation.

When the read count 111 reaches a threshold value, the controller 110 may perform a management operation to maintain data reliability. The management operation may include protecting data and correcting errors by reprogramming or updating the data. For example, the management operation may include a refresh operation, a reclaim operation, a reprogramming operation, a wear leveling operation, or the like. If the management operation is not performed at an appropriate time while repeated read operations are executed on the memory device 120, the data may become corrupted due to excessive reading. On the contrary, if the management operation is performed too frequently without necessity, it may shorten the lifespan of the memory device 120.

When there is a significant difference between a temperature at the time of data programming (referred to as “programming time point”) and a temperature at the time of data reading (referred to as “read time point”), the data reliability may degrade. Accordingly, the controller 110 may determine an increment of the read count 111 based on the temperature at the read time point and increase the read count 111 accordingly.

For example, if the controller 110 determines that the temperature at the read time point falls within a normal temperature zone, the controller 110 may set the increment of the read count 111 to a first value, such as 1. However, if the temperature at the read time point falls within an abnormal temperature zone, the controller 110 may set the increment of the read count 111 to a second value that is greater than the first value. In such a case, the controller 110 may assign a weight to the increment of the read count 111, allowing the read count 111 to reach the threshold value more quickly and triggering the management operation sooner to maintain the data reliability.

The definition of the “read time point” may vary according to embodiments. In an embodiment, the read time point may refer to a time point when the controller 110 transmits the read command to the memory device 120. In another example, the read time point may refer to a time point when the read operation begins in the memory device 120. In further another embodiment, the read time point may refer to a time point when the controller 110 receives the read data from the memory device 120.

The controller 110 may manage temperature information 112. The temperature information 112 may include temperature update time points UT, which represent the moments when temperature is sensed, and corresponding temperatures T at the temperature update time points UT. An interval between temperature update time points UT (e.g., update time interval) may be set to a predetermined duration, such as one second. A temperature sensor (not shown) configured to sense the temperature may be included in the memory device 120. The controller 110 may control the memory device 120 to transmit the temperature sensed at each temperature update time point UT or as needed. Additionally, the controller 110 may include a temperature memory (not shown) configured to store the temperature information 112.

According to another embodiment, the temperature sensor may be included in the controller 110. The controller 110 may sense the temperature using the temperature sensor and generate the temperature information 112 at each temperature update time point UT.

As described above, to accurately determine the increment of the read count 111 and perform the management operation at the appropriate time, it is necessary to identify the temperature zone at the read time point. When the read time point coincides with one of the temperature update time points UT in the temperature information 112, the controller 110 may determine the temperature zone at the read time point based on the corresponding temperature update time point UT. However, in cases where the read time point does not coincide with any of the temperature update time points UT in the temperature information 112, the accurate temperature at the read time point may not be explicitly recorded in the temperature information 112. Nevertheless, the controller 110 may more accurately determine whether the temperature at the read time point falls within the abnormal temperature zone or the normal temperature zone with reference to the temperature information 112.

For example, the read time point for the read operation of the memory device 120 may fall between a first temperature update time point and a second temperature update time point. In such a case, the controller 110 may refer to a first temperature at the first temperature update time point and a second temperature at the second temperature update time point in the temperature information 112. If any one of the first temperature and the second temperature falls within the abnormal temperature zone, the controller 110 may determine that the temperature zone is changed between the first temperature update time point and the second temperature update time point. When the temperature zone is changed, the controller 110 may further determine a temperature zone change time point at which the temperature zone is changed based on the temperature information 112.

The controller 110 may determine whether the temperature at the read time point falls within the abnormal temperature zone based on the temperature information 112 and the temperature zone change time point. For example, if the first temperature is within the normal temperature zone, the second temperature is within the abnormal temperature zone, and the read time point occurs after the temperature zone change time point, the controller 110 may determine that the temperature at the read time point falls within the abnormal temperature zone. Conversely, if the first temperature is within the abnormal temperature zone, the second temperature is within the normal temperature zone, and the read time point occurs before the temperature zone change time point, the controller 110 may also determine that the temperature at the read time point falls within the abnormal temperature zone.

If both the first temperature and the second temperature fall within the normal temperature zone, the controller 110 may determine that the temperature at the read time point, occurring between the first temperature update time point and the second temperature update time point, is also within the normal temperature zone. Similarly, if both the first temperature and the second temperature fall within the abnormal temperature zone, the controller 110 may determine that the temperature at the read time point is within the abnormal temperature zone.

As described above, the time point at which the read count 111 is increased for the read operation may vary according to embodiments. According to an embodiment, at the time point at which the read count 111 is increased for the read operation, the first temperature at the first temperature update time point just before the read time point may be within the temperature information 111, while the second temperature at the second temperature update time point just after the read time point may not be yet updated in the temperature information 112. Accordingly, the controller 110 may determine a preliminary increment based on the first temperature and increase the read count 111 by the preliminary increment. For example, if the first temperature falls within the normal temperature zone, the controller 110 may set the preliminary increment to the first value. Conversely, if the first temperature falls within the abnormal temperature zone, the controller 110 may set the preliminary increment to the second value that is greater than the first value.

The controller 110 may determine whether the temperature zone is changed based on the first temperature and the second temperature at the second temperature update time point. If a change in the temperature zone is detected, the controller 110 may determine the temperature zone change time point. For example, if the first temperature and the second temperature are within different temperature zones, the controller 110 may determine that the temperature zone is changed. In such a case, the controller 110 may substitute a boundary temperature, which defines the different temperature zones, into a temperature function over time that is generated based on the temperature information 112.

The controller 110 may determine whether compensation for the read count is necessary based on the temperature zone change time point and, if so, adjust the read count accordingly. For example, if the read time point falls between the temperature zone change time point and the second temperature update time point, the controller 110 may determine that the compensation for the read count is necessary. In such a case, the controller 110 may reduce the read count by a first compensation value when the second temperature falls within the normal temperature zone and increase the read count by a second compensation value when the second temperature falls within the abnormal temperature zone.

According to an embodiment, the controller 110 may determine the temperature zone change time point by substituting the boundary temperature, which distinguishes the different temperature zones, into the temperature function over time that is generated based on the temperature information 112.

According to an embodiment, the controller 110 may calculate the temperature zone change time point and identify an internal operation of the memory device 120, such as a read operation, a program operation, an erase operation, and the like, which is performed in the abnormal temperature zone, based on the temperature zone change time point. If the identified internal operation is a program or erase operation, the controller 110 may store information related to that internal operation. When the temperature returns to the normal temperature zone, the controller 110 may perform a management operation using the stored information. For example, since the corresponding internal operation may have been performed unstably in the abnormal temperature zone, the controller 110 may perform the management operation on a memory region on which the internal operation was performed to ensure reliability.

The memory device 120 may perform the read operation, the program operation, the erase operation, and the like under the control of the controller 110.

The storage device 100 may include a personal computer memory card international association (PCMCIA) card, a smart media card, a memory stick, any of various multimedia cards such as MMC, eMMC, RS-MMC, and MMC-micro, any of secure digital cards such as SD, Mini-SD, and Micro-SD, a universal flash storage (UFS), or a solid state drive (SSD).

The memory device 120 may include a NAND flash memory, a three-dimensional (3D) NAND flash memory, a NOR flash memory, a resistive random access memory (RRAM), a phase-change random access memory (PRAM), a magnetoresistive random access memory (MRAM), a ferroelectric random access memory (FRAM), a spin transfer torque random access memory (STT-RAM), or the like.

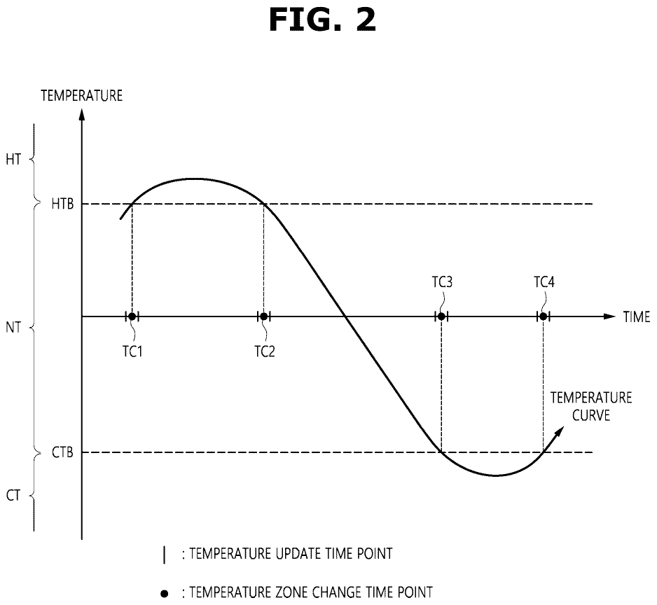

FIG. 2 is a diagram illustrating temperature zone change time points TC1 to TC4 according to an embodiment.

Referring to FIG. 2, temperature change over time is illustrated. The temperature falls within one of three zones: a normal temperature zone NT, a hot temperature zone HT, or a cold temperature zone CT. The hot temperature zone HT and the cold temperature zone CT may collectively form the abnormal temperature zone. The hot temperature zone HT and the cold temperature zone CT may adversely affect the operational performance and data reliability of the storage device 100. The boundary between the normal temperature zone NT and the hot temperature zone HT is defined by a hot boundary temperature HTB, and the boundary between the normal temperature zone NT and the cold temperature zone CT is defined by a cold boundary temperature CTB.

The temperature zone may be changed at the temperature zone change time points TC1 to TC4. At each of these time points TC1 to TC4, the temperature may correspond to either the hot boundary temperature HTB or the cold boundary temperature CTB. For example, before the temperature zone change time point TC1, the temperature is in the normal temperature zone NT, and after the temperature zone change time point TC1, the temperature transitions to the hot temperature zone HT. Similarly, before the temperature zone change time point TC2, the temperature is in the hot temperature zone HT, and after the temperature zone change time point TC2, the temperature returns to the normal temperature zone NT. Before the temperature zone change time point TC3, the temperature is in the normal temperature zone NT, and after the temperature zone change time point TC3, the temperature transitions to the cold temperature zone CT. Likewise, before the temperature zone change time point TC4, the temperature is in the cold temperature zone CT, and after the temperature zone change time point TC4, the temperature returns to the normal temperature zone NT. The temperature zone change time points TC1 to TC4 may not coincide with the temperature update time points UT.

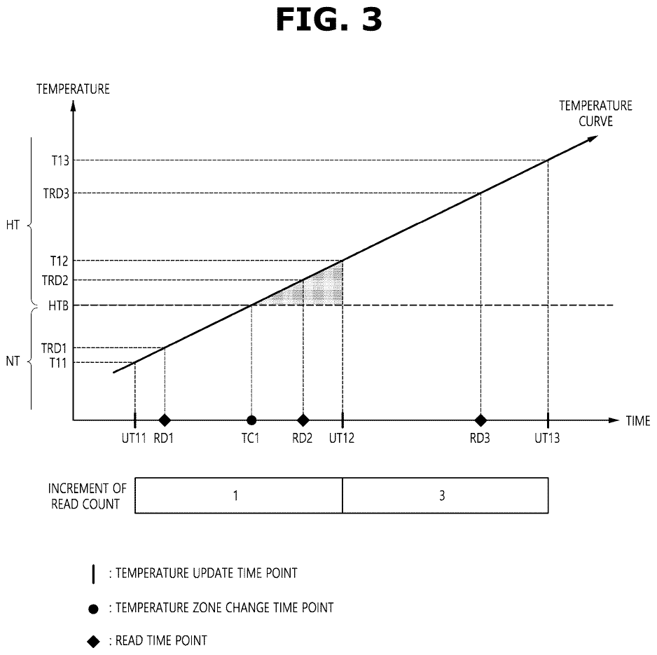

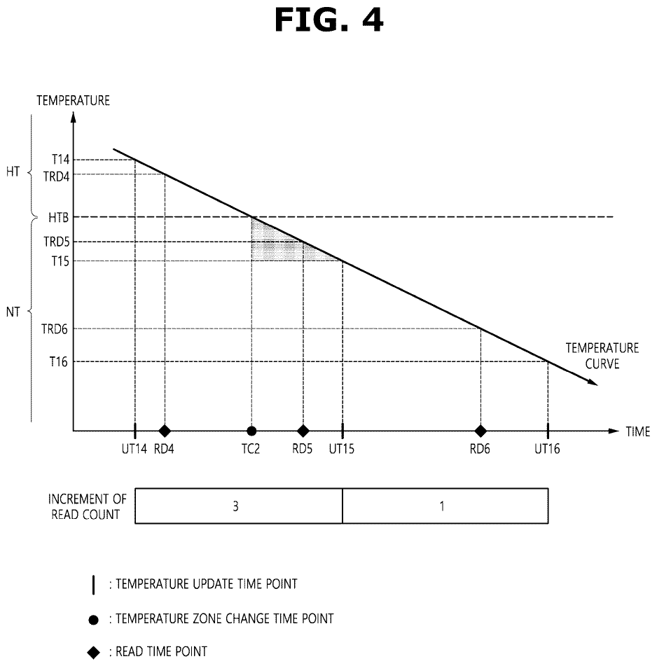

FIGS. 3 and 4 are diagrams illustrating a method for determining the increment of the read count 111 without considering the temperature zone change time points TC1 and TC2 according to an embodiment. The controller 110 may assume that a read operation performed between successive first and second temperature update time points is performed in a temperature zone including the temperature at the first temperature update time point.

Referring to FIG. 3, a first read time point RD1 for a first read operation and a second read time point RD2 for a second read operation occur between temperature update time points UT11 and UT12. A third read time point RD3 for a third read operation occurs between temperature update time points UT12 and UT13. The temperature is in the normal temperature zone NT before the temperature zone change time point TC1, which occurs between the temperature update time points UT11 and UT12. After the temperature zone change time point TC1, the temperature transitions to the hot temperature zone HT.

The controller 110 may determine temperatures T11 to T13 at the temperature update time points UT11 to UT13 based on the temperature information 112. The controller 110 may determine that the temperature T11 at the temperature update time point UT11 is within the normal temperature zone NT. Since the temperature T11 is within the normal temperature zone NT, the controller 110 may also consider that a temperature TRD1 at the first read time point RD1 and a temperature TRD2 at the second read time point RD2 are both within the normal temperature zone NT. Consequently, the controller 110 may set the increment of the read count 111 for both the first read operation and the second read operation to the first value, for example, 1.

The controller 110 may determine that the temperature T12 at the temperature update time point UT12 is within the hot temperature zone HT. Since the temperature T12 is within the hot temperature zone HT, the controller 110 may also consider that a temperature TRD3 at the third read time point RD3 is within the hot temperature zone HT. Based on this, the controller 110 may set the increment of the read count 111 for the third read operation to the second value, for example, 3.

When the temperature TRD1 at the first read time point RD1 is within the normal temperature zone NT, it is desirable for the increment of the read count 111 for the first read operation to be set to 1. Similarly, when the temperature TRD3 at the third read time point RD3 is within the hot temperature zone HT, it is desirable for the increment of the read count 111 for the third read operation to be set to 3. However, when the temperature TRD2 at the second read time point RD2 is actually within the hot temperature zone HT, it would be undesirable for the increment of the read count 111 for the second read operation to be set to 1. If the read count 111 is insufficiently increased in cases like the second read operation, such as when read operations are performed in a shaded zone, the management operation may not be performed at the appropriate time, which could degrade data reliability.

Referring to FIG. 4, a fourth read time point RD4 for a fourth read operation and a fifth read time point RD5 for a fifth read operation occur between temperature update time points UT14 and UT15. A sixth read time point RD6 for a six read operation occurs between temperature update time points UT15 and UT16. The temperature is within the hot temperature zone HT before the temperature zone change time point TC2, which occurs between the temperature update time points UT14 and UT15. After the temperature zone change time point TC2, the temperature transitions to the normal temperature zone NT.

The controller 110 may determine the temperatures at the temperature update time points UT14 to UT16 based on the temperature information 112. The controller 110 may determine that a temperature T14 at the temperature update time point UT14 falls within the hot temperature zone HT. Since the temperature T14 is within the hot temperature zone HT, the controller 110 may also consider that both a temperature TRD4 at the fourth read time point RD4 and a temperature TRD5 at the fifth read time point RD5 fall within the hot temperature zone HT. As a result, the controller 110 may set the increment of the read count 111 for both the fourth read operation and the fifth read operation to the second value, for example, 3.

The controller 110 may determine that a temperature T15 at the temperature update time point UT15 falls within the normal temperature zone NT. Since the temperature T15 is within the normal temperature zone NT, the controller 110 may also consider that a temperature TRD6 at the sixth read time point RD6 is within the normal temperature zone NT. As a result, the controller 110 may set the increment of the read count 111 for the sixth read operation to the first value, for example, 1.

As described above, when the temperature TRD4 at the fourth read time point RD4 is within the hot temperature zone HT, it is desirable for the increment of the read count 111 for the fourth read operation to be set to 3. When the temperature TRD6 at the sixth read time point RD6 is within the normal temperature zone NT, it is desirable for the increment of the read count 111 for the sixth operation to be set to 1. However, when the temperature TRD5 at the fifth read time point RD5 is actually within the normal temperature zone NT, it would be undesirable for the increment of the read count 111 for the fifth read operation to be set to 3. If the read count 111 is excessively increased, as in the case of the fifth read operation (such as when read operations are performed in a shaded zone), unnecessary management operations may be performed, which could shorten the lifespan of the memory device 120.

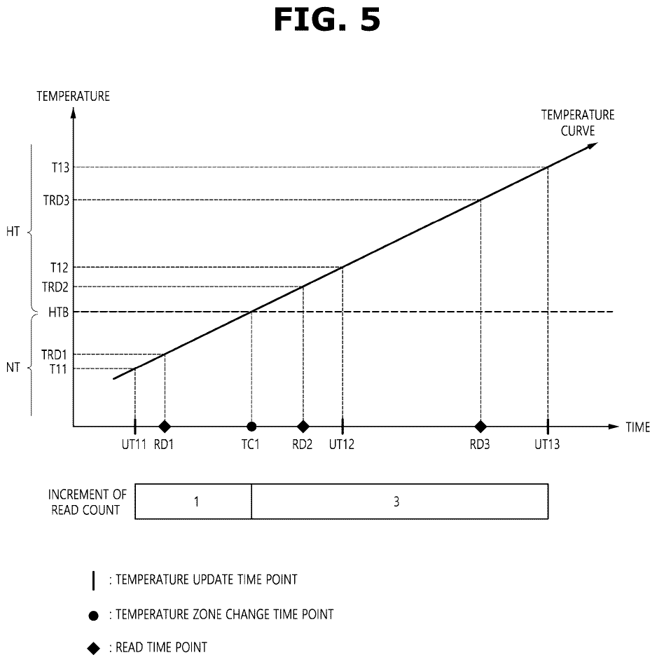

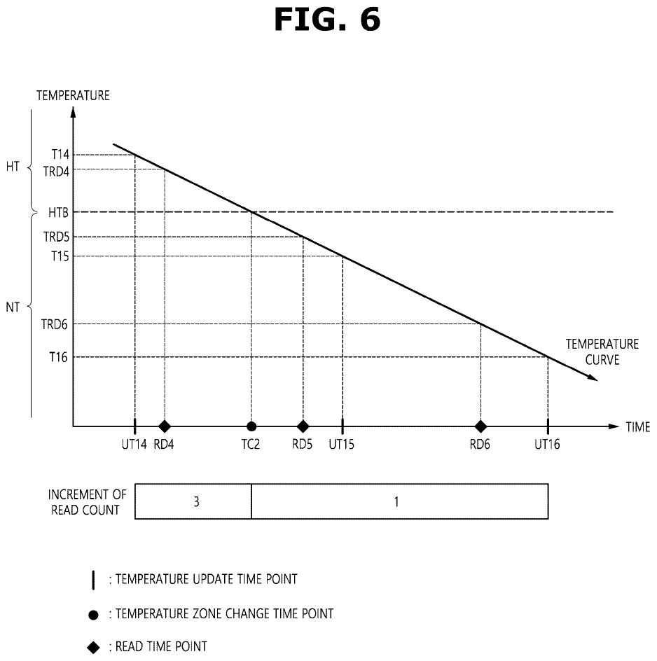

FIGS. 5 and 6 are diagrams illustrating a method for determining the increment of the read count 111 by determining a temperature zone change time point TC according to an embodiment.

First, based on the first temperature update time point UT1, the first temperature T1 at the first temperature update time point UT1, the second temperature update time point UT2, the second temperature T2 at the second temperature update time point UT2, and a boundary temperature TB, the temperature zone change time point TC may be determined according to the following Equation 1. The first temperature T1 and the second temperature T2 may be within different temperature zones. The second temperature update time point UT2 may occur after a certain update time interval from the first temperature update time point UT1. The boundary temperature TB may be either the hot boundary temperature HTB or the cold boundary temperature CTB, which lies between the first temperature T1 and the second temperature T2.

$$TC = UT 1 + ( TB - T 1 ) * ( UT 2 - UT 1 ) / ( T 2 - T 1 ) \qquad [ Equation 1 ]$$

Equation 1 may be derived under the assumption that the relationship between the temperature update time points UT and the temperatures T included in the temperature information 112 (i.e., the temperature function) follows a first-order function. According to an embodiment, the temperature function may be determined using various function estimation methods, such as machine learning, regression analysis, and numerical analysis.

Referring to FIG. 5, a temperature T11 at a temperature update time point UT11 is within the normal temperature zone NT and a temperature T12 at a temperature update time point UT12 is within the hot temperature zone HT. Thus, the controller 110 may determine that the temperature zone is changed between the temperature update time points UT11 and UT12. Accordingly, the controller 110 may calculate a temperature zone change time point TC1 between the temperature update time points UT11 and UT12 using Equation 1.

For example, the controller 110 may calculate the temperature zone change time point TC1 by substituting the temperature update time points UT11 and UT12 as the first and second temperature update time points UT1 and UT2, respectively, into Equation 1. Similarly, the temperatures T11 and T12 may be substituted as the first and second temperatures T1 and T2, respectively, into Equation 1, and the hot boundary temperature HTB may be substituted as the boundary temperature TB into Equation 1. After calculating the temperature zone change time point TC1, the controller 110 may compare each of read time points RD1 and RD2 with the temperature update time points UT11 and UT12 and the temperature zone change time point TC1.

For example, the temperature T11 is within the normal temperature zone NT, the temperature T12 is within the hot temperature zone HT, and the first read time point RD1 occurs between the temperature update time point UT11 and the temperature zone change time point TC1. Thus, the controller 110 may determine that a temperature TRD1 at the first read time point RD1 is within the normal temperature zone NT. Accordingly, the controller 110 may determine that the increment of the read count 111 for the first read operation is 1.

The temperature T11 is within the normal temperature zone NT, the temperature T12 is within the hot temperature zone HT, and the second read time point RD2 occurs between the temperature zone change time point TC1 and the temperature update time point UT12. Thus, the controller 110 may determine that a temperature TRD2 at the second read time point RD2 is within the hot temperature zone HT. Accordingly, the controller 110 may determine that the increment of the read count 111 for the second read operation is 3.

Since both the temperatures T12 and T13 are within the hot temperature zone HT, the controller 110 may determine that a temperature TRD3 at a third read time point RD3 is also within the hot temperature zone HT. Accordingly, the controller 110 may determine that the increment of the read count 111 for the third read operation is 3.

According to an embodiment, before the temperature update time point UT12, the temperature T11 at the temperature update time point UT11 is within the normal temperature zone NT. Thus, the controller 110 may determine the preliminary increment of the read count 111 for both the first read operation and the second read operation to be 1, and increase the read count 111 for each of the first read operation and the second read operation by 1. After the temperature update time point UT12, the controller 110 may calculate the temperature zone change time point TC1 as described above. Since the first read time point RD1 occurs between the temperature update time point UT11 and the temperature zone change time point TC1, the controller 110 may determine that no compensation for the read count 111 is necessary for the first read operation. However, the second read time point RD2 occurs between the temperature zone change time point TC1 and the temperature update time point UT12, the controller 110 may determine that compensation for the read count 111 is necessary for the second read operation. The controller 110 may then increase the read count 111 by 2, as the temperature T12 is within the hot temperature zone HT.

Referring to FIG. 6, a temperature T14 at a temperature update time point UT14 is within the hot temperature zone HT, and a temperature T15 at a temperature update time point UT15 is within the normal temperature zone NT. Thus, the controller 110 may determine that the temperature zone is changed between the temperature update time points UT14 and UT15. Accordingly, the controller 110 may calculate a temperature zone change time point TC2 between the temperature update time points UT14 and UT15 using Equation 1.

For example, the controller 110 may calculate the temperature zone change time point TC2 by substituting the temperature update time points UT14 and UT15 as the first and second temperature update time points UT1 and UT2, respectively, into Equation 1. Similarly, the temperatures T14 and T15 are substituted as the first and second temperatures T1 and T2, respectively, into Equation 1, and the hot boundary temperature HTB is substituted as the boundary temperature TB into Equation 1. After calculating the temperature zone change time point TC2, the controller 110 may compare the read time points RD4 and RD5 against the temperature update time points UT14 and UT15, as well as the temperature zone change time point TC2.

For example, since the temperature T14 is within the hot temperature zone HT and the temperature T15 is within the normal temperature zone NT, the controller 110 may determine that the temperature zone change occurs between them. Since the fourth read time point RD4 occurs between the temperature update time point UT14 and the temperature zone change time point TC2, the controller 110 may determine that the temperature TRD4 at the fourth read time point RD4 is within the hot temperature zone HT. Accordingly, the controller 110 may set the increment of the read count 111 for the fourth read operation to 3.

Since the temperature T14 is within the hot temperature zone HT and the temperature T15 is within the normal temperature zone NT, the controller 110 may determine that the temperature zone change occurs between them. Since the fifth read time point RD5 occurs between the temperature zone change time point TC2 and the temperature update time point UT15, the controller 110 may determine that the temperature TRD5 at the fifth read time point RD5 is within the normal temperature zone NT. Accordingly, the controller 110 may set the increment of the read count 111 for the fifth read operation to 1.

Since both the temperatures T15 and T16 are within the normal temperature zone NT, the controller 110 may determine that a temperature TRD6 at a sixth read time point RD6 is also within the normal temperature zone NT. Accordingly, the controller 110 may set the increment of the read count 111 for the six read operation to 1.

According to an embodiment, before the temperature update time point UT15, the temperature T14 at the temperature update time point UT14 is within the hot temperature zone HT. Therefore, the controller 110 may initially determine the increment of the read count 111 for both the fourth read operation and the fifth read operation as 3, increasing the read count 111 accordingly. After the temperature update time point UT15, the controller 110 may calculate the temperature zone change time point TC2 as described above. Since the fourth read time point RD4 occurs between the temperature update time point UT14 and the temperature zone change time point TC2, the controller 110 may determine that no compensation for the read count 111 is necessary for the fourth read operation. However, as the fifth read time point RD5 occurs between the temperature zone change time point TC2 and the temperature update time point UT15, the controller 110 may determine that compensation for the read count 111 is necessary for the fifth read operation. Consequently, the controller 110 may reduce the read count 111 for the fifth read operation by 2, based on the determination that the temperature T15 is within the normal temperature zone NT.

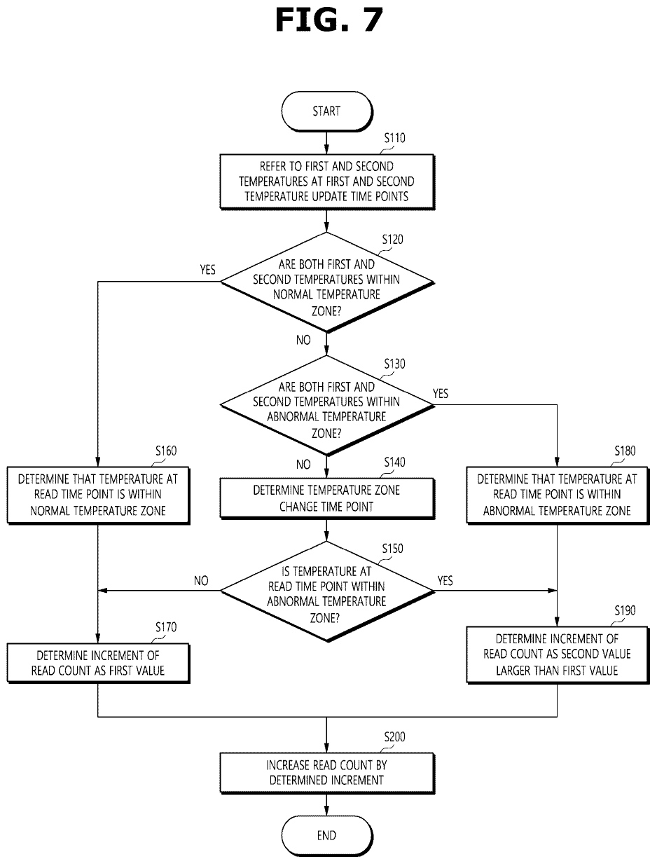

FIG. 7 is a flowchart illustrating an operating method of the controller 110 according to an embodiment. A procedure illustrated in FIG. 7 may be a method by which, when a read time point for the memory device 120 falls between the first temperature update time point UT1 and the second temperature update time point UT2, the controller 110 accurately determines the corresponding temperature zone. This determination is based on the first temperature T1 at the first temperature update time point UT1 and the second temperature T2 at the second temperature update time point UT2. The controller 110 then adjusts the read count 111 by applying a temperature-compensated increment in a single step. When increasing the read count 111 after the second temperature update time point UT2, the controller 110 may follow the procedure illustrated in FIG. 7.

Referring to FIG. 7, in operation S110, the controller 110 refers to the first temperature T1 at the first temperature update time point UT1 (immediately preceding the read time point) and the second temperature T2 at the second temperature update time point UT2 (immediately following the read time point) from the temperature information 112.

In operation S120, the controller 110 determines whether both the first temperature T1 at the first temperature update time point UT1 and the second temperature T2 at the second temperature update time point UT2 are within the normal temperature zone NT. If both the first temperature T1 and the second temperature T2 are within the normal temperature zone NT, the procedure proceeds to operation S160. Otherwise, if at least one of the first temperature T1 or the second temperature T2 is outside the normal temperature zone NT, the procedure proceeds to operation S130.

In operation S130, the controller 110 determines whether both the first temperature T1 and the second temperature T2 are within the abnormal temperature zone, such as the hot temperature zone HT or the cold temperature zone CT. If both the first temperature T1 and the second temperature T2 are within the abnormal temperature zone, the procedure proceeds to operation S180. Otherwise, if any one of the first temperature T1 and the second temperature T2 is within the abnormal temperature zone and the other is within the normal temperature zone NT, the procedure proceeds to operation S140.

In operation S140, the controller 110 determines that the temperature zone is changed between the first temperature update time point UT1 and the second temperature update time point UT2 and determine the temperature zone change time point TC based on the temperature information 112. The controller 110 calculates the temperature zone change time point TC by substituting the boundary temperature TB, which distinguishes the abnormal temperature zone (including the first temperature T1 or the second temperature T2) from the normal temperature zone NT, into the temperature function over time, generated based on the temperature information 112. For example, the controller 110 may determine the temperature zone change time point TC using Equation 1 above.

In operation S150, the controller 110 determines whether a temperature at the read time point is within the abnormal temperature zone based on the temperature information 112 and the temperature zone change time point TC. If the first temperature T1 is within the normal temperature zone NT, the second temperature T2 is within the abnormal temperature zone, and the temperature zone change time point TC occurs before the read time point, or if the first temperature T1 is within the abnormal temperature zone, the second temperature T2 is within the normal temperature zone NT, and the read time point precedes the temperature zone change time point TC, the controller 110 determines that the temperature at the read time point is within the abnormal temperature zone. If it is determined that the temperature at the read time point is within the abnormal temperature zone, the procedure proceeds to operation S190. If it is determined that the temperature at the read time point is not in the abnormal temperature zone, the procedure proceeds to operation S170.

In operation 160, the controller 110 determines that the temperature at the read time point is within the normal temperature zone NT.

In operation S170, the controller 110 determines the increment of the read count 111 as the first value.

In operation S180, the controller 110 determines that the temperature at the read time point is within the abnormal temperature zone.

In operation S190, the controller 110 determines the increment of the read count 111 as the second value, which is larger than the first value.

In operation S200, the controller 110 increases the read count 111 by the determined increment.

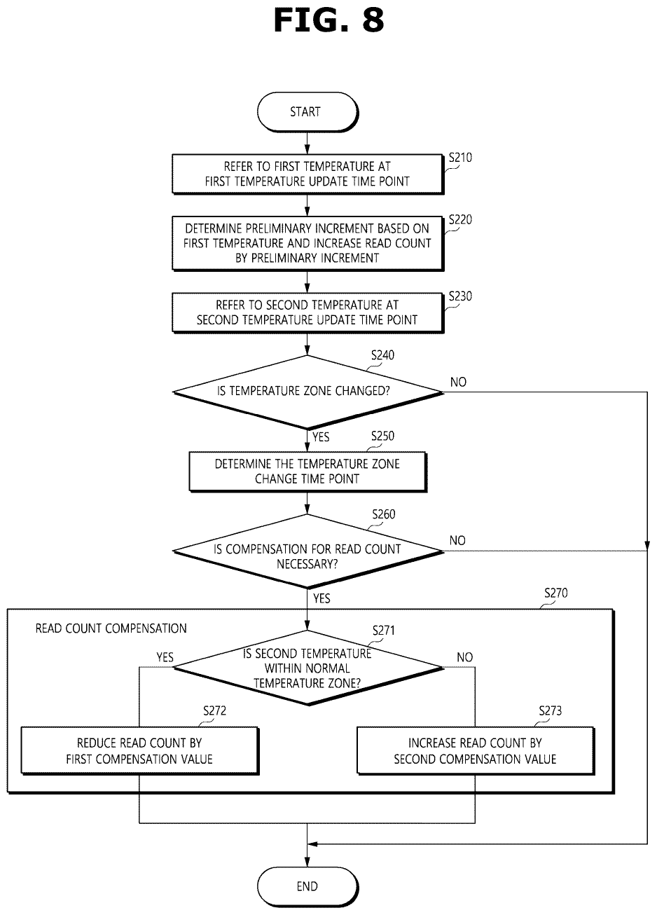

FIG. 8 is a flowchart illustrating an operating method of the controller 110 according to an embodiment. Differently from FIG. 7, a procedure illustrated in FIG. 8 allows the controller 110 to estimate a temperature zone corresponding to the read time point based on the first temperature T1 at the first temperature update time point UT1 when the first temperature update time point UT1 is followed by the read time point for the memory device 120, and the second temperature update time point UT2 has not yet arrived. The controller 110 then increases the read count 111 by the preliminary increment. After that, the controller 110 may accurately determine the temperature zone corresponding to the read time point based on the second temperature T2 at the second temperature update time point UT2 and adjust (for example, additionally increase or reduce) the read count 111 accordingly.

Referring to FIG. 8, in operation S210, the controller 110 refers to the first temperature T1 at the first temperature update time point UT1 just before the read time point from the temperature information 112. The first temperature T1 at the first temperature update time point UT1 may be the most recent temperature available in the temperature information 112.

In operation S220, the controller 110 determines the preliminary increment of the read count 111 based on the first temperature T1 and increase the read count 111 by the preliminary increment. For example, if the first temperature T1 is within the normal temperature zone NT, the controller 110 may determine the preliminary increment as the first value. Accordingly, the temperature at the read time point may be considered to be within the normal temperature zone NT. However, if the first temperature T1 is within the abnormal temperature zone, the controller 110 may determine the preliminary increment as the second value, which is larger than the first value. Accordingly, the temperature at the read time point may be considered to be within the abnormal temperature zone.

In operation S230, the controller 110 refers to the second temperature T2 at the second temperature update time point UT2 just after the read time point from the temperature information 112.

In operation S240, the controller 110 determines whether the temperature zone is changed between the first temperature update time point UT1 and the second temperature update time point UT2 based on the first temperature T1 and the second temperature T2. If the first temperature T1 and the second temperature T2 are within different temperature zones, the controller 110 may determine that the temperature zone is changed. If both the first temperature T1 and the second temperature T2 are within the same temperature zone, the controller 110 may determine that the temperature zone is not changed. When it is determined that the temperature zone is changed, the procedure proceeds to operation S250. On the other hand, when it is determined that the temperature zone is not changed, the procedure is terminated.

In operation S250, the controller 110 determines the temperature zone change time point TC when the temperature zone is changed between the first temperature update time point UT1 and the second temperature update time point UT2. The controller 110 calculates the temperature zone time point TC by substituting the boundary temperature TB, which distinguishes the abnormal temperature zone, including the first temperature T1 or the second temperature T2, from the normal temperature zone NT, into the temperature function over time, generated based on the temperature information 112. For example, the controller 110 may determine the temperature zone change time point TC using Equation 1 above.

In operation S260, the controller 110 determines whether compensation for the read count 111 is necessary based on the temperature zone change time point TC. If the read time point is between the temperature zone change time point TC and the second temperature update time point UT2, the controller 110 may determine that the compensation for the read count 111 is necessary. If the read time point is not between the temperature zone change time point TC and the second temperature update time point UT2, the controller 110 may determine that the compensation for the read count 111 is unnecessary. When it is determined that the compensation for the read count 111 is necessary, the procedure proceeds to operation S270. On the other hand, when it is determined that the compensation for the read count 111 is unnecessary, the procedure is terminated.

In operation S270, the controller 110 compensates the read count 111. Operation S270 may include operations S271 to S273.

For example, in operation S271, the controller 110 determines whether the second temperature T2 is within the normal temperature zone NT. If the second temperature T2 is within the normal temperature zone NT, the procedure proceeds to operation S272. If not, e.g., if the second temperature T2 is within the abnormal temperature zone, the procedure proceeds to operation S273.

In operation S272, the controller 110 reduces the read count 111 by a first compensation value. According to an embodiment, the first compensation value may be a difference between the second value and the first value. For example, if the read time point was initially considered to be in the abnormal temperature zone in operation S220 but is confirmed to be in the normal temperature zone in operation S260, the controller 110 compensates the read count 111, which is preliminarily increased by the second value in operation S220, by reducing the read count 111 by the first compensation value.

In operation S273, the controller 110 increases the read count 111 by a second compensation value. According to an embodiment, the second compensation value may be a difference between the second value and the first value. For example, if the read time point was initially considered to be in the normal temperature zone in operation S220 but is confirmed to be in the abnormal temperature zone in operation S260, the controller 110 compensates the read count 111, which is preliminarily increased by the first value in operation S220, by increasing the read count 111 by the second compensation value.

According to an embodiment, the controller 110 may transmit the read command to the memory device 120, and then perform operations S110 to S200 of FIG. 7 or operations S210 to S270 of FIG. 8. According to another embodiment, the controller 110 may perform operations S110 to S200 of FIG. 7 or operations S210 to S270 of FIG. 8 in parallel with the read operation for the memory device 120. According to still another embodiment, the controller 110 may perform operations S110 to S200 of FIG. 7 or operations S210 to S270 of FIG. 8 in response to completion of the read operation for the memory device 120.

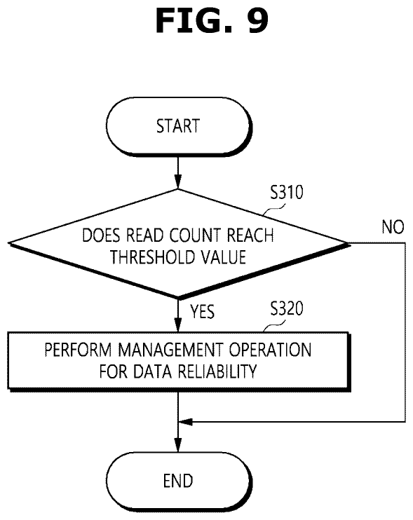

FIG. 9 is a flowchart illustrating an operating method of the controller 110 according to an embodiment.

Referring to FIG. 9, in operation S310, the controller 110 determines whether the read count 111 reaches a threshold value. If the read count 111 does not reach the threshold value, the procedure is terminated. If the read count 111 reaches the threshold value, the procedure proceeds to operation S320.

In operation S320, the controller 110 performs a management operation to ensure data reliability.

The above described embodiments of the present invention are intended to illustrate and not to limit the present invention. Various alternatives and equivalents are possible. The invention is not limited by the embodiments described herein. Nor is the invention limited to any specific type of semiconductor device. Other additions, subtractions, or modifications are obvious in view of the present disclosure and are intended to fall within the scope of the appended claims.

What is claimed is:

1. A storage device comprising:
a memory device; and
a controller configured to:
when a temperature zone is changed between a first temperature update time point and a second temperature update time point, determine a temperature zone change time point based on temperature information, wherein the temperature information includes a first temperature at the first temperature update time point and a second temperature at the second temperature update time point;
check whether a temperature at a read time point for the memory device is within an abnormal temperature zone based on the temperature information and the temperature zone change time point, wherein the read time point occurs between the first temperature update time point and the second temperature update time point; and
increase a read count by an increment determined based on a result of the checking.

2. The storage device of claim 1, wherein the controller is configured to:
when one of the first temperature and the second temperature is within the abnormal temperature zone and the other is within a normal temperature zone, determine that the temperature zone is changed between the first temperature update time point and the second temperature update time point.

3. The storage device of claim 1, wherein the controller is configured to determine that the temperature at the read time point is within the abnormal temperature zone when the first temperature is within a normal temperature zone, the second temperature is within the abnormal temperature zone, and the temperature zone change time point is followed by the read time point, or when the first temperature is within the abnormal temperature zone, the second temperature is within the normal temperature zone, and the read time point precedes the temperature zone change time point.

4. The storage device of claim 1, wherein the controller is configured to:
determine that the temperature at the read time point is within a normal temperature zone when both the first temperature and the second temperature are within the normal temperature zone; and
determine that the temperature at the read time point is within the abnormal temperature zone when both the first temperature and the second temperature are within the abnormal temperature zone.

5. The storage device of claim 1, wherein the controller is configured to set the increment to a first value when the temperature at the read time point is outside the abnormal temperature zone and to a second value, larger than the first value, when the temperature at the read time point is within the abnormal temperature zone.

6. The storage device of claim 1, wherein the controller is configured to determine the temperature zone change time point by applying a boundary temperature, which distinguishes different temperature zones, to a temperature function over time derived from the temperature information.

7. The storage device of claim 1, wherein the controller is configured to perform a management operation for data reliability based on the read count that is increased.

8. An operating method of a controller of a storage device, the method comprising:
determining a preliminary increment based on a first temperature at a first temperature update time point preceding a read time point and increasing a read count by the preliminary increment;
determining whether a temperature zone is changed based on the first temperature and a second temperature at a second temperature update time point following the read time point, and determining a temperature zone change time point when the temperature zone is changed; and
determining whether compensation for the read count increased by the preliminary increment is necessary based on the temperature zone change time point, and compensating the read count when the compensation is necessary.

9. The method of claim 8, wherein the determining of the preliminary increment includes:
setting the preliminary increment to a first value when the first temperature is within a normal temperature zone; and
setting the preliminary increment to a second value, larger than the first value, when the first temperature is within an abnormal temperature zone.

10. The method of claim 8, wherein the determining whether a temperature zone is changed includes determining that the temperature zone is changed when the first temperature and the second temperature are within different temperature zones.

11. The method of claim 10, wherein the determining of the temperature zone change time point includes applying a boundary temperature, which distinguishes the different temperature zones, to a temperature function over time derived from temperature information including the first temperature and the second temperature.

12. The method of claim 8, wherein the determining whether compensation for the read count is necessary includes determining that the compensation for the read count is necessary when the read time point occurs between the temperature zone change time point and the second temperature update time point.

13. The method of claim 8, wherein the compensating the read count includes reducing the read count by a first compensation value when the second temperature is within a normal temperature zone and increasing the read count by a second compensation value when the second temperature is within an abnormal temperature zone.

14. A storage device, comprising:
a memory device; and
a controller configured to:
calculate a temperature zone change time point between a first temperature update time point and a second temperature update time point based on a first temperature at the first temperature update time point and a second temperature at the second temperature update time point, wherein the temperature zone change time point corresponds to a boundary temperature distinguishing an abnormal temperature zone from a normal temperature zone; and
identify an internal operation of the memory device performed in the abnormal temperature zone based on the temperature zone change time point.

15. The storage device of claim 14, wherein the controller is configured to determine that the internal operation is performed in the abnormal temperature zone when the first temperature is within the normal temperature zone, the second temperature is within the abnormal temperature zone, and a time point of performing the internal operation is between the temperature zone change time point and the second temperature update time point, or when the first temperature is within the abnormal temperature zone, the second temperature is within the normal temperature zone, and the time point of performing the internal operation is between the first temperature update time point and the temperature zone change time point.

16. The storage device of claim 14, wherein the controller is configured to calculate the temperature zone change time point by applying the boundary temperature to a temperature function over time derived from the first temperature and the second temperature.

17. The storage device of claim 14, wherein the controller is configured to assign a weight to an increment of a read count when the internal operation performed in the abnormal temperature zone is a read operation.

18. The storage device of claim 14, wherein the controller is configured to store information related to the internal operation when the internal operation performed in the abnormal temperature zone is a program operation or an erase operation.
